(19) United States
(12) Patent Application Publication
(10) Pub. No.: US 2023/0189035 A1
(43) Pub. Date: Jun. 15, 2023

(54) GROUP-BASED BEAM REPORT WITH MULTIPLE REPORTED GROUPS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 17/793,323

(22) PCT Filed: Jan. 25, 2021
(86) PCT No.: PCT/CN2021/073489

§ 371 Date: Jul. 15, 2022

(30) Foreign Application Priority Data
Feb. 7, 2020 (WO) PCT/CN2020/074483

(51) Int. Cl. H04W 24/10; H04B 7/06; H04B 17/336; H04B 17/318; H04W 24/08

(52) U.S. Cl. CPC H04W 24/10; H04B 7/0626; H04B 17/336; H04B 17/318; H04W 24/08

(57) ABSTRACT

Aspects enable a user equipment (UE) to provide group-based beam reporting for multiple groups of beams. The UE measures a signal for each of a plurality of beams, wherein the plurality of beams are grouped into multiple groups of more than one beam that are capable of simultaneous operation. The UE transmits a channel state information (CSI) report comprising a group-based beam report for each of the multiple groups of more than one beam. Each group-based beam report comprised in the CSI report may indicate a beam metric for each beam of the more than one beam in a corresponding group. Each group-based beam report comprised in the CSI report may indicate a group beam metric for the one or more beams comprised in a corresponding group. A base station may configure the UE for the group-based beam reporting for multiple groups of more than one beam.

### CROSS REFERENCE TO RELATED APPLICATION(S)

This application claims the benefit of International Application Serial No. PCT/CN2020/074483, entitled “Group-Based Beam Report with Multiple Reported Groups” and filed on Feb. 7, 2020, which is expressly incorporated by reference herein in its entirety.

### BACKGROUND

### Technical Field

The present disclosure relates generally to communication systems, and more particularly, to wireless communication including direction beams.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus measures a signal for each of a plurality of beams, wherein the plurality of beams are grouped into multiple groups of more than one beam that are capable of simultaneous operation. The apparatus transmits a channel state information (CSI) report comprising a group-based beam report for each of the multiple groups of more than one beam, wherein each group-based beam report comprised in the CSI report indicates a beam metric for each beam of the more than one beam in a corresponding group.

In another aspect of the disclosure, a method, a computer-readable medium, and an apparatus are provided for wireless communication at a user equipment. The apparatus measures a signal for each of a plurality of beams, wherein the plurality of beams are grouped into multiple groups of more than one beam that are capable of simultaneous operation. The apparatus transmits a CSI report comprising a group-based beam report for each of the multiple groups of more than one beam, wherein each group-based beam report comprised in the CSI report indicates a group beam metric for the one or more beams comprised in a corresponding group.

In another aspect of the disclosure, a method, a computer-readable medium, and an apparatus are provided for wireless communication at a base station. The apparatus configures a UE for group-based beam reporting for multiple groups of more than one beam that are capable of simultaneous operation. The apparatus receives, from the UE, a CSI report comprising a group-based beam report for each of the multiple groups of more than one beam, wherein each group-based beam report comprised in the CSI report indicates a beam metric for each beam of the more than one beam in a corresponding group.

In another aspect of the disclosure, a method, a computer-readable medium, and an apparatus are provided for wireless communication at a base station. The apparatus configures a UE for group-based beam reporting for multiple groups of more than one beam receives, from the UE, the group-based beam report for each of the multiple groups of more than one beam, wherein a group beam metric is reported for each of the multiple groups.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 is a diagram showing beamformed communication between a UE and a base station.

FIG. 5 illustrates example aspects for reporting per-beam measurements in a group-based beam report for multiple groups of beams.

FIG. 6 illustrates example aspects for reporting per-beam measurements in a group-based beam report for multiple groups of beams.

FIG. 7 illustrates example aspects for reporting per-beam measurements in a group-based beam report for multiple groups of beams.

FIG. 8 illustrates example aspects for reporting per-beam measurements in a group-based beam report for multiple groups of beams.

FIG. 9 illustrates example aspects for reporting group beam measurements in a group-based beam report for multiple groups of beams.

FIG. 10 illustrates example aspects for reporting group beam measurements in a group-based beam report for multiple groups of beams.

FIG. 11 is a flowchart of a method of wireless communication.

FIG. 12 is a flowchart of a method of wireless communication.

FIG. 13 is a diagram illustrating an example of a hardware implementation for an example apparatus

FIG. 14 is a flowchart of a method of wireless communication.

FIG. 15 is a flowchart of a method of wireless communication.

FIG. 16 is a diagram illustrating an example of a hardware implementation for an example apparatus

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

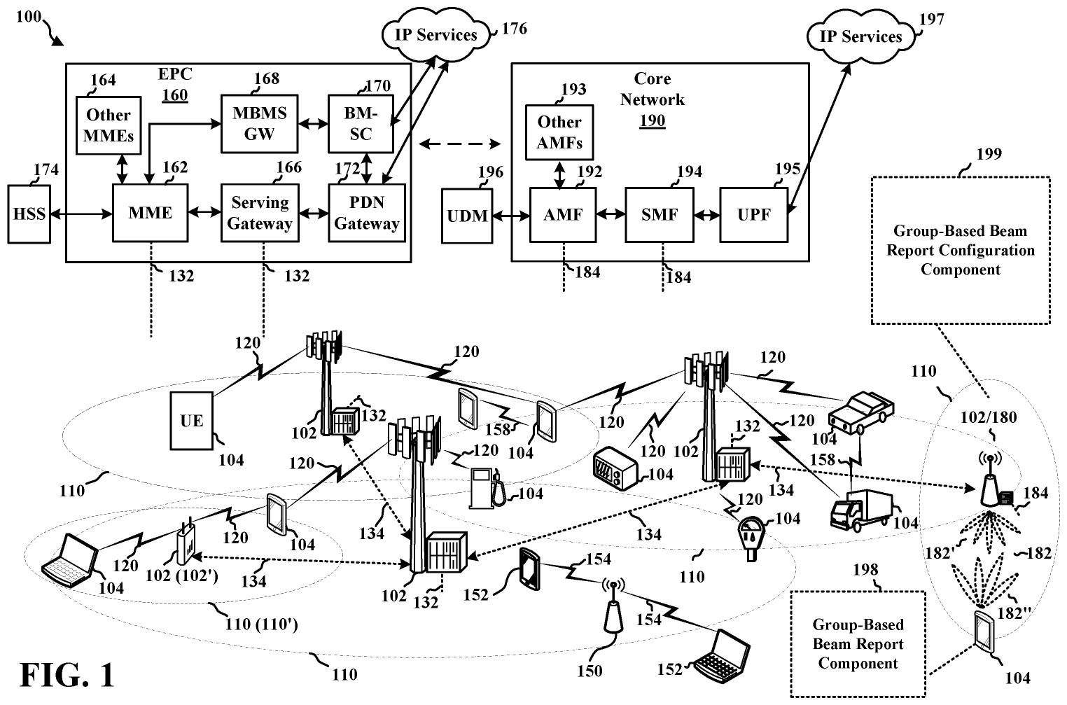

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to YMHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 may be referred to as mid-band frequencies. Although a portion of FR1 is greater than 6 GHz, FR1 may be referred to (interchangeably) as a “sub-6 GHz” band. A similar nomenclature issue may occur with regard to FR2, which may be referred to (interchangeably) as a “millimeter wave” band, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave,” “mmW,” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near millimeter wave may extend down to a frequency of 3 GHz with a wavelength of 100 millimeters. The super high frequency (SHF) band extends between 3 GHz and 30 GHz, also referred to as centimeter wave. Communications using the millimeter wave/near millimeter wave radio frequency (RF) band (e.g., 3 GHz-300 GHz) has extremely high path loss and a short range. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in some examples, the UE 104 may measure a signal for each of a plurality of beams 182′ and/or 182″. The plurality of beams may be grouped into multiple groups of more than one beam. The UE may include a group-based beam report component 198 that is configured to transmit, to the base station 102 or 180, a group-based beam report for each of the multiple groups of more than one beam. A beam metric may be reported for each beam in each of the multiple groups. A group beam metric may be reported for each of the multiple groups. The beam metric may include a reference signal received power (RSRP) and/or a signal to interference and noise ratio (SINR) The base station may 102 or 180 may include a group-base beam report configuration component 199 that configures the UE 104 for the group-based beam reporting for multiple groups of more than one beam. Although the following description may be focused on 5G NR, the concepts described herein may be applicable to other similar areas, such as LTE, LTE-A, CDMA, GSM, and other wireless technologies.

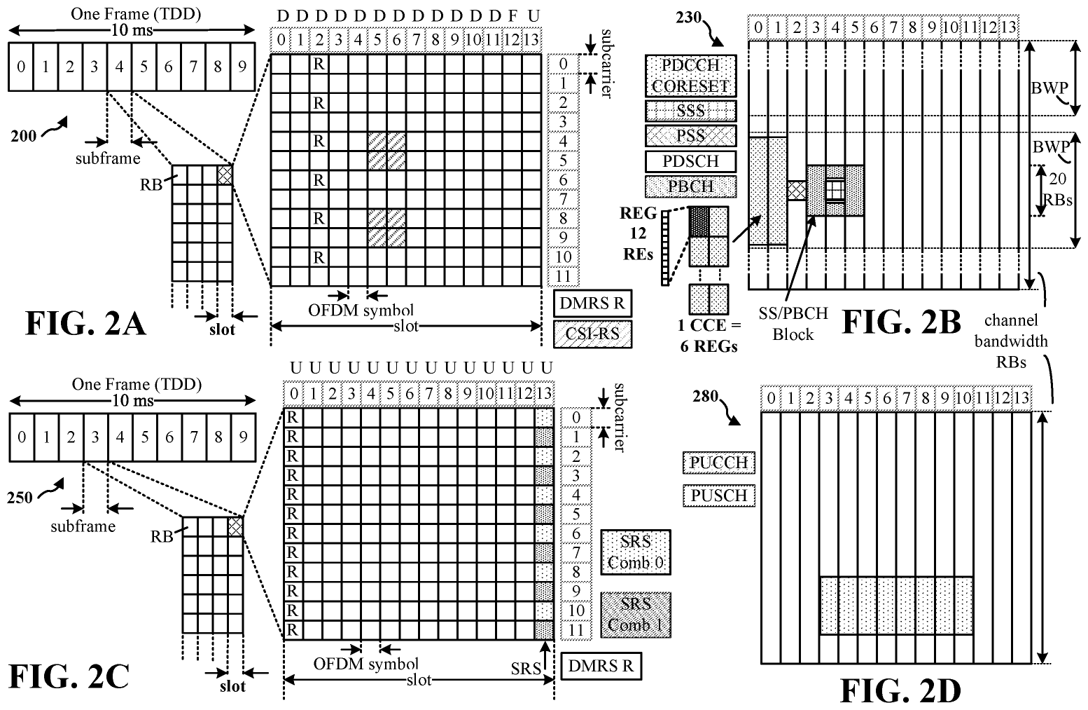

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (which may also be referred to as an SS block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARD) acknowledgment (ACK) (HARQ-ACK) information/negative ACK (NACK), e.g., ACK/NACK, feedback. The PUSCH carries data, and may additionally be used to carry a buffer status report (BSR), a power headroom report (PHR), and/or UCI.

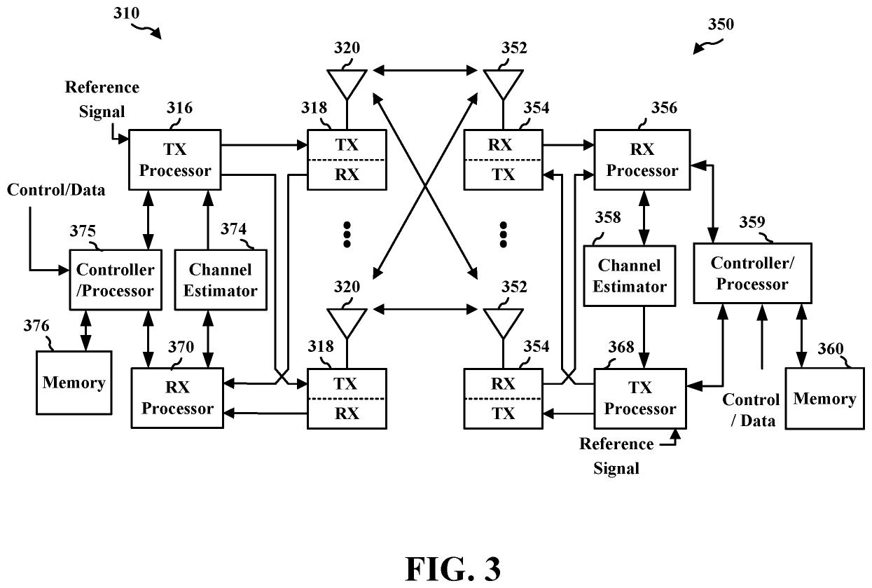

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 198 of FIG. 1.

As described in connection with FIG. 1, a UE 104 and a base station 102/180 may communicate using beams. The base station and the UE may perform beam management in order to select and adjust beams for communication between the UE and the base station. The UE may be mobile and/or the environment between the base station and the UE may change. Thus, beam adjustments (e.g., the selection of a different beam for transmission and/or reception) may be needed in order to address movement, change of orientation, change of environment, etc.

The base station may provide opportunities for the UE to measure beamformed channels of different combinations of transmission beams from the base station and UE reception beams by transmitting a downlink reference signal using different transmission beams, e.g., in a beam sweep over the different beams. The base station may provide a beam management configuration to UE with information about beam measurements for the UE to perform and/or beam reports for the UE to provide to the base station. The beam management configuration may include a channel state information reference signal (CSI-RS) resource configuration, a beam report setting, etc. For example, a CSI report configuration (e.g., which may be referred to as a “CSI-ReportConfig”) may configure the UE to report beam measurements of (e.g., based on measurements of a CSI-RS transmission from the base station).

The base station may perform periodic beam sweeping by transmitting a reference signal using different, individual transmission beams. The UE may measure information about a beamformed channel state using different UE reception beams and may report the measurements to the base station. The UE may report measurement information such as a reference signal received power (RSRP), channel state information (CSI), etc. After the UE detects the reference signal and performs the measurements, the UE may send information about the beams back to the base station. The report may include a CSI report. The UE may use CSI-RSs and/or a synchronization signal block (SSBs) to perform measurements for different beams and to provide a CSI report. The SSB is used for initial access and may not require additional overhead for use in beam management. The SSB may have limited bandwidth, whereas CSI-RS may be configured with a different frequency range. The transmission of a CSI-RS for beam management may use additional overhead, yet may enable flexibility in the allocation of resources for the reference signal.

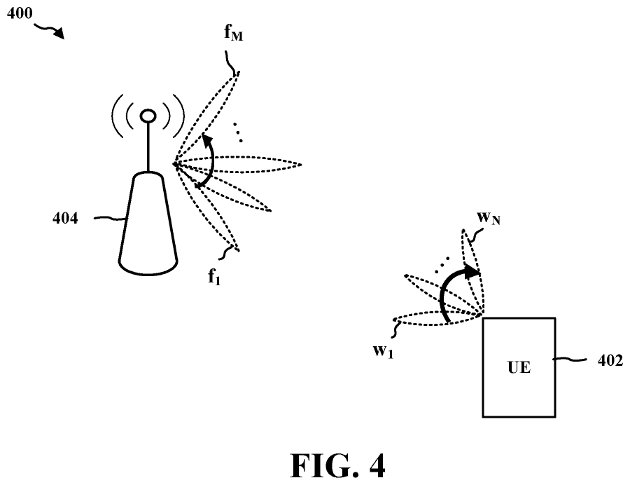

FIG. 4 illustrates an example communication system 400 including a base station 404 having M beams, e.g., beams f₁, . . . f_{M}, and a UE 402 having N beams, e.g., beams w₁, . . . , w_{N}. A beam pair may include a transmission beam for the base station and a reception beam for the UE.

Beam management may be performed on a per beam basis with the UE measuring and reporting for individual beams. For example, a UE 402 may perform beam management for a cell provided by the base station 404. Group-based beam reporting may reduce signaling or feedback overhead for beam management. For example, beam management may be performed and reported for a group of beams rather than for individual beams. Group-based beam management can be performed such that beam tracking and refinement may be performed for a group of beams.

The group-based beam reporting may reduce reporting compared to non-group-based beam reporting. A group-based beam report may include measurement information for a representative beam measured by a UE. The representative beam may be one of the beams in the group of beams or may represent an average of the measurements for the beams in the group. For example, the representative beam may be a beam that has a maximum measurement value compared to other beams in the group. The group-based report may include a RSRP for the representative beam and/or a differential RSRP for a different beam in the beam group. The beam-based report may include measurement information for individual beams. The group-based report may have less information about individual beams than the beam-based report

A group-based beam report may be based on a report quantity set, a CRI-RSRP or SSB-index-RSRP. As an example, the UE may be configured with a CSI report configuration having a higher layer report quantity parameter (e.g., “reportQuantity”) that is configured as CRI-RSRP or SSB-Index-RSRP. Based on whether the UE is configured for CRI-RSRP or SSB-Index-RSRP, the UE may report a CSI-RS resource indicator (CRI) or synchronization signal/physical broadcast channel Resource Block Indicator (SSBRI) for the measured beams. The group-based beam reporting may include an L1-SINR metric.

If the UE is configured with the higher layer parameter for group-Based Beam reporting disabled, the UE may refrain from updating measurements for more than 64 CSI-RS and/or SSB resources, and the UE may report in a single report measured RS resources. The number of measured RS resources for a cell that are reported by the UE may be based on a higher layer parameter configured by the base station (an example of such a parameter is “nrofReportedRS”) that may indicate a number of N measured RS resources to be reported per report setting in a non-group-based report. Thus, the UE may report N different CRI or SSBRI for each report setting.

If the UE is configured with the higher layer parameter for group-based beam reporting enabled, the UE may refrain from updating measurements for more than 64 CSI-RS and/or SSB resources, and the UE may report in a single reporting instance two different CRI or SSBRI for each report setting. The beams may be capable of simultaneous operation, e.g., the CSI-RS and/or SSB resources may be received simultaneously by the UE either with a single spatial domain receive filter or with multiple simultaneous spatial domain receive filters. Thus, the UE may send a group beam report for a single group of two beams. The UE may report a largest L1-RSRP from the measured reference signals and/or a differential L1-RSRP with respect to a largest measured RSRP. Thus, the UE may report an absolute RSRP (or the measured RSRP) for the first beam, and a differential RSRP for the second beam with respect to the absolute RSRP of the first beam.

Aspects presented herein enable a UE to report multiple groups of more than one beam. The beams may be capable of simultaneous operation, e.g., the CSI-RS and/or SSB resources may be received simultaneously by the UE either with a single spatial domain receive filter or with multiple simultaneous spatial domain receive filters. Aspects may enable the UE to report multiple groups with different metrics, e.g., RSRP, SINR, capacity, etc. The aspects presented herein may enable the UE to efficiently provide more comprehensive beam information to the base station, and may enable improved beam management between the UE and the base station.

In some examples, the UE may provide group-based beam report information for multiple groups of beams that includes a per-beam metric. The per-beam metric may include an L1-RSRP and/or a L1-SINR for individual beams within the groups of beams.

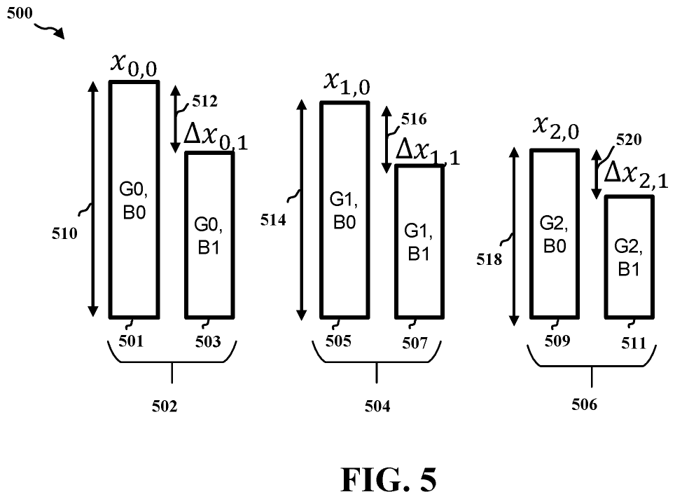

For example, the UE may report an absolute metric value for a first transmission beam in each group of beams. The UE may then report a different value for the remaining transmission beams within each group. The differential value may be with respect to the first beam within the group. The first beam, for which the absolute metric value is report, may be a strongest transmission beam from the group of beams. FIG. 5 illustrates an example 500 showing example beam metric measurements for three groups of transmission beams, each group having two transmission beams. A first group 502 (which may be referred to as G0) includes beam 501 and beam 503. A second group 504 (which may be referred to as G1) includes beam 505 and beam 507. A third group 506 (which may be referred to as G2) includes beam 509 and beam 511. Three groups are illustrated in order to illustrate the concept. The UE may report only two groups of beams or may report more than three groups of beams. Similarly, a group may include more than two beams.

In the first group 502, the absolute value 510 of a metric, such as RSRP or SINR, may be reported for the first beam 501. The first beam may be the strongest beam, for example. Then, a differential value 512, with respect to the absolute value 510 of the first beam 501, may be reported for the second beam 503. In the second group 504, the absolute value 514 of a metric, such as the measured value of RSRP or SINR for the beam, may be reported for the first beam 505. The first beam may be the strongest beam in the second group 504, for example. Then, a differential value 516, with respect to the absolute value 514 of the first beam 505 in the group 504, may be reported for the second beam 507 in the group 504. In the third group 506, the absolute value 518 of a metric, such as RSRP or SINR, may be reported for the first beam 509. The first beam may be the strongest beam in the third group 506, for example. Then, a differential value 520, with respect to the absolute value 518 of the first beam 509 in the group 506, may be reported for the second beam 511 in the group 506.

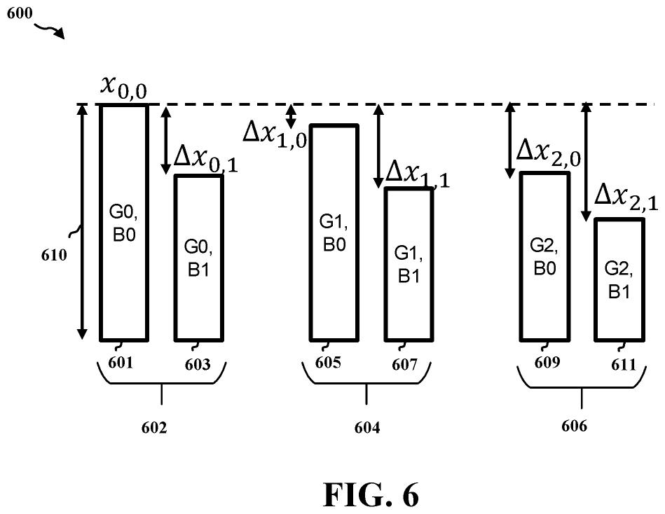

In another example, an absolute metric may be provided for a first beam from the beams grouped into the multiple groups. The first beam may be a strongest beam of all the reported beams, e.g., from each of the groups. The absolute metric value may be referred to as a global strongest value because it is the strongest among multiple groups of transmission beams. Then, a different value may be reported for the other beams with respect to the globally strongest value. FIG. 6 illustrates an example 600 showing example beam metric measurements for three groups of transmission beams, each group having two transmission beams. A first group 602 includes beam 601 and beam 603. A second group 604 includes beam 605 and beam 607. A third group 606 includes beam 609 and beam 611. In FIG. 6, beam 601 is the strongest beam and has the highest metric value. Therefore, the UE may report the absolute value 610 of the measured metric for the beam 601. For the other beams of the first group 602, as well as the beams in the other groups 604 and 606 (e.g., for each of beams 603, 605, 607, 609, and 611), the UE may report a differential value with respect to the globally strongest value, e.g., 610.

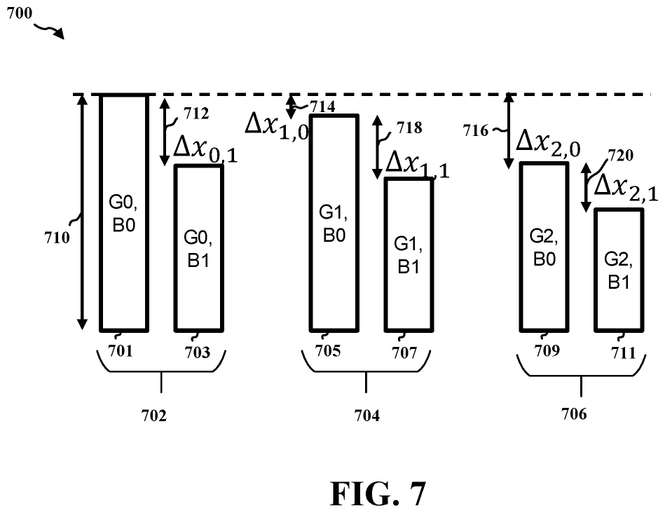

FIG. 7 illustrates an example 700 using an absolute value of a metric for a globally strongest beam, similar to FIG. 6. A first group 702 includes beam 701 and beam 703. A second group 704 includes beam 705 and beam 707. A third group 706 includes beam 709 and beam 711. In FIG. 7, beam 701 is the strongest beam and has the highest metric value. Therefore, the UE may report the absolute value 710 of the measured metric for the beam 701. The other beam in the first group, e.g., beam 703, may be reported using a differential value 712 with respect to the absolute value 710. In the other groups 704 and 706, one or more beams may be reported using a differential value with respect to the absolute value 710. FIG. 7 illustrates a differential value 714 for the beam 705 with respect to the absolute value 710 of the globally strongest beam. Similarly, a differential value 716 may be provided for the beam 709 with respect to the absolute value 710 of the globally strongest beam. The beams 705 and 709 may be strongest beams within their respective groups. Other beams within the groups 704 and 706 may be reported based on a differential value to an absolute value of the strongest beam within the corresponding group. Thus, the beam 707 may be reported using a differential value 718 with respect to the absolute value of the beam 705. Similarly, the beam 711 may be reported using a differential value 720 with respect to the absolute value of the beam 709.

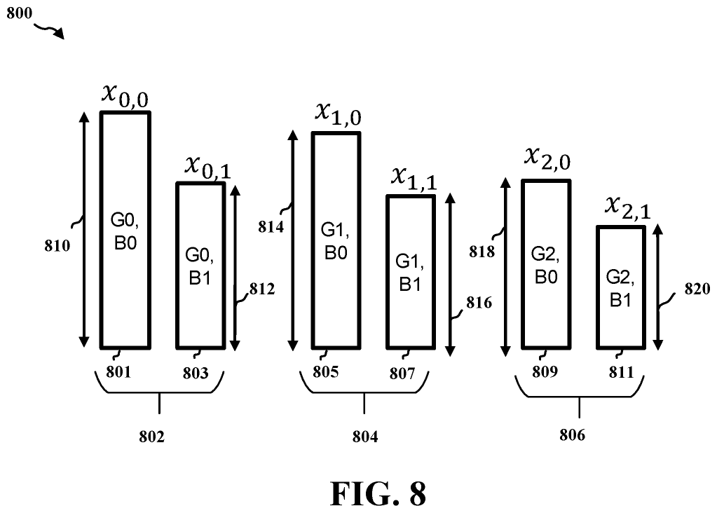

FIG. 8 illustrates an example 800 in which an absolute metric value (e.g., 810, 812, 814, 816, 818, and 820) is reported for each transmission beam (e.g., 801, 803, 805, 807, 809, 811) in the groups (e.g., 802, 804, 806).

When the UE sends the group-based beam report, the groups of beams (e.g., group 502, 504, 506 from FIG. 5) may be sorted based on measurement values of the beams within the group. For example, the beams may be reported in an order based on strongest beams. In the example in FIG. 6, the beam report may be ordered based on the group having the strongest beams. Thus, the metrics for group 602 may be listed first because the beam 601 is the strongest of each of the measured beams. The metrics for group 604 may be listed second because beam 605 is stronger than the beams in group 606. The metrics for group 606 may be listed third. When the UE reports a differential value from an absolute metric value, the absolute metric value serving as a reference may be the digitalized value in the report which is post-quantization, or may be the analog value from the measurement which is pre-quantization.

In another example, the beam report may be ordered based on the weakest beam. In this example, the measurements for group 606 may be reported first, because beam 611 is weakest among all the beams. The measurements for group 604 may be reported second, because the beam 607 is weaker than the beam 603 in group 602. Then, the measurements for group 602 may be reported third.

In another example, the beam report may be ordered based on a largest or a smallest average measurement for the beams within a group. In the example in FIG. 6, if the beam report uses an order of groups based on an average beam strength measurement, the measurements for groups in the beam report may be ordered from largest average to lowest average as group 602, group 604, group 606.

In some examples, the group-based beam report may include a per-group metric. The per-group metric may include a combined SINR for the beams within a group, a capacity for the beams within a group, and/or other mutual information for beams within a group. As an example of a combined SINR for the beams within a group may correspond to a single SINR that reflects the quality of the group of multiple beams. One example of a combined SINR is a linear weighted value based on the multiple SINRs for individual beams. The UE may indicate other types of a combined SINR other than a linear weighted value. The capacity may be based on a spectral efficiency for the beams within the group. Similar to the combined SINR, the group-based beam report may indicate a single capacity value that indicates a combined spectral efficiency for the beams within the group.

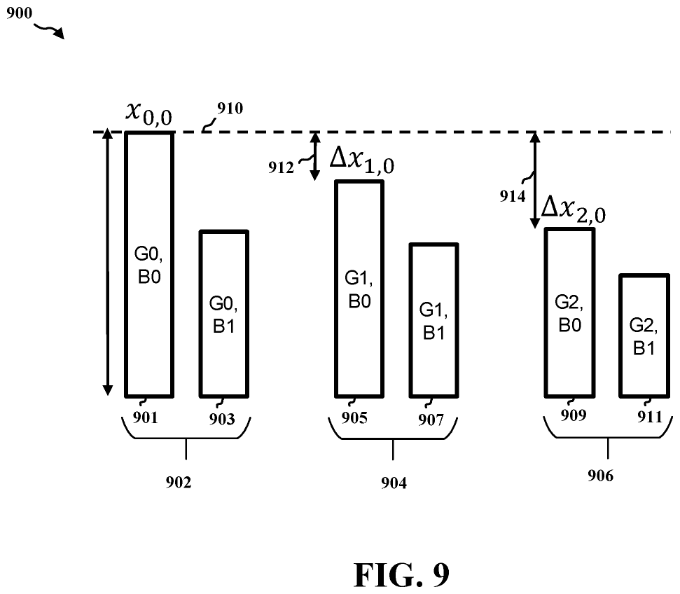

In some examples, an absolute group metric value may be reported for the first group, and a differential value may be reported for the other groups with respect to the absolute group metric value of the first group. The first group, for which the absolute metric value is reported, may be the group having a largest value among the groups. Each of the remaining groups may then have a differential value reported within respect to the largest value. FIG. 9 illustrates an example 900 of groups 902, 904, and 906 having beams 901, 903, 905, 907, 909, and 911, respectively. In FIG. 9, the group 902 may have a largest group metric, whether a combined SINR, capacity, etc. The absolute value of the metric may have an absolute value of 910, which may be included in the group-based beam report for the group 902. The metrics for the other groups may be included in the group-based beam report as a differentia value 912 or 914 with respect to the absolute value 910 for the group 902. The representative group, for which the absolute value of the group-based beam metric is reported, may be the group having the largest value among the groups, e.g., a largest combined SINR, a largest capacity, or other mutual information. When the UE reports a differential value from an absolute metric value, the absolute metric value serving as a reference may be the digitalized value in the report which is post-quantization, or may be the analog value from the measurement which is pre-quantization.

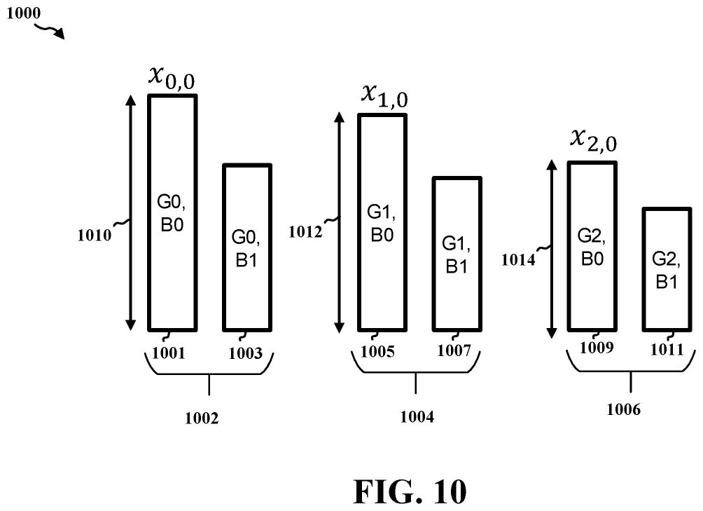

In another example, an absolute metric value may be reported for the per-group metrics for each group, e.g., the combined SINR for each group, the capacity for each group, etc. FIG. 10 illustrates an example 1000 showing groups 1002, 1004, and 1006 each having an absolute value for the group metric. Thus, the absolute value 1010 is reported as the combined group metric for the beams 1001 and 1003 of the group 1002, e.g., the combined SINR for beams 1001 and 1003, the capacity for beams 1001 and 1003, etc. The absolute value 1012 is reported as the combined group metric for the beams 1005 and 1007 of the group 1004. The absolute value 1014 is reported as the combined group metric for the beams 1009 and 1011 of the group 1006.

When the UE sends the group-based beam report, the metrics may be reported per group in an ascending or descending order. For example, as the group 1002 in FIG. 10 has a highest combined metric, the combined metric for group 1002 may be indicated first, followed by the combined metric for group 1004 and group 1006.

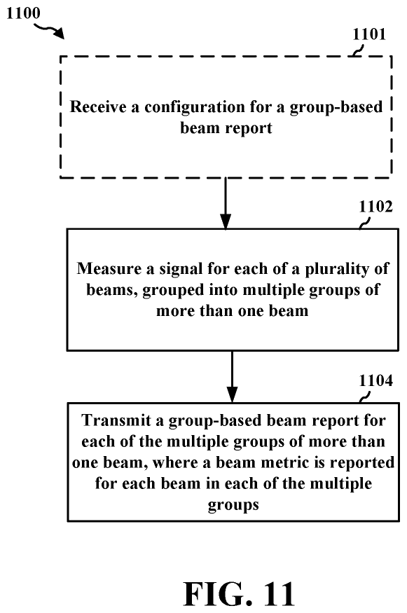

FIG. 11 is a flowchart 1100 of a method of wireless communication. The method may be performed by a UE or a component of a UE (e.g., the UE 104, 350, 402; the apparatus 1302; a processing system, which may include the memory 360 and which may be the entire UE 350 or a component of the UE 350, such as the TX processor 368, the RX processor 356, and/or the controller/processor 359). The method may enable the UE to efficiently provide more comprehensive beam information for a group of beams.

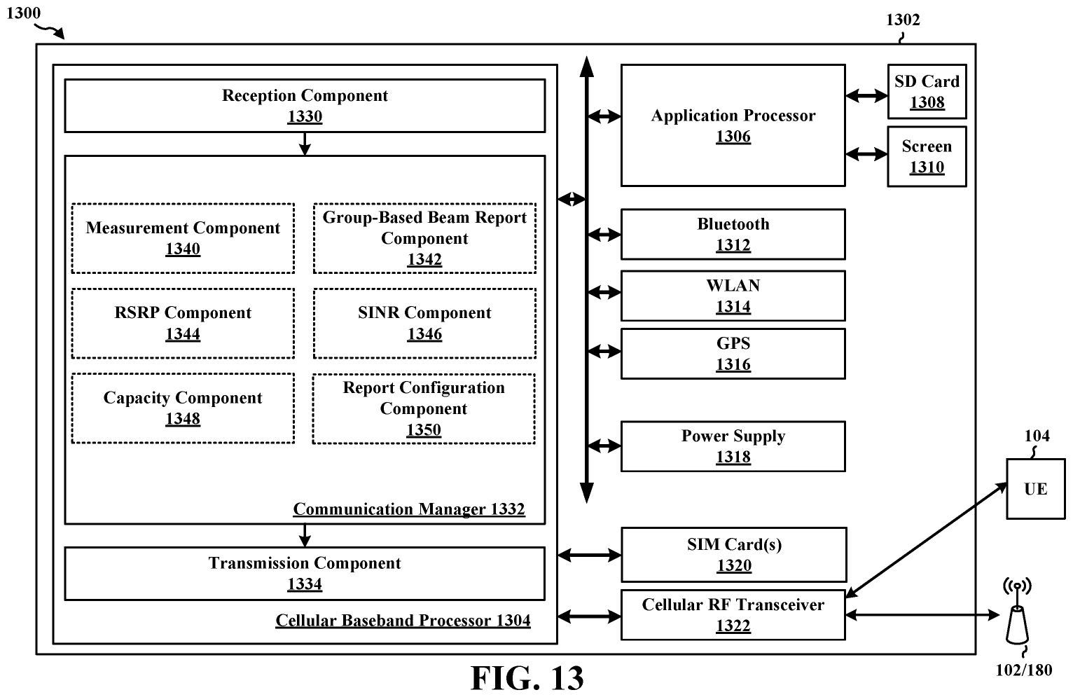

At 1102, the UE measures a signal for each of a plurality of beams. The UE may perform measurements for the beams based on aspects described in connection with FIG. 4. The plurality of beams are grouped into multiple groups of more than one beam, e.g., as described in connection with any of FIGS. 5-10. The beams may be capable of simultaneous operation, e.g., the CSI-RS and/or SSB resources may be received simultaneously by the UE either with a single spatial domain receive filter or with multiple simultaneous spatial domain receive filters. The measurement of the signal for each of the plurality of beams may be performed by the measurement component 1340 of the apparatus 1302 in FIG. 13.

At 1104, the UE transmits a CSI report comprising a group-based beam report for each of the multiple groups of more than one beam, where each group-based beam report comprised in the CSI report indicates a beam metric for each beam of the more than one beam in a corresponding group. Thus, a beam metric is reported for each beam in each of the multiple groups. The transmission of the beam metric may be performed by the group-based beam report component 1342 via the transmission component 1334 of the apparatus 1302 in FIG. 13. The beam metric may comprise at least one of an RSRP or an SINR, e.g., for each of the beams of the groups. For example, the RSRP may be determined by the RSRP component 1344 of the apparatus 1302 in FIG. 13. The SINR may be determined by the SINR component 1346 of the apparatus 1302.

For each group of more than one beam, the UE may report an absolute metric value for a first beam in the group, and a differential metric value (e.g., a delta value) with respect to the absolute metric value may be reported for each remaining beam in the group, such as described in connection with the example in FIG. 5. For example, if the metric is an RSRP measurement for the beam, the UE may report the RSRP measurement for a first beam in the group and may report a delta RSRP measurement or a differential RSRP measurement for the other beams relative to the RSRP measurement for the first beam. The RSRP may be measurement in db, and the differential value may indicate a difference value for RSRP in dB. For example, the first beam may have an RSRP measurement of X db, a second beam may have an RSRP measurement of X+3 db, and a third beam may have an RSRP measurement of X-2 db. The UE may report the X db measurement for the first beam and may indicate a differential value of 3 (e.g., db) for the second beam and −1 (e.g., db) for the third beam. RSRP is merely one example of a metric that may be reported for each beam. Among other examples, the metric may be based on SINR, RSRP and SINR, etc.

In some examples, the UE may report an absolute metric value for a first beam in a first group, and a differential metric value (e.g., a delta value) with respect to the absolute metric value may be reported for each remaining beam in each of the multiple groups, such as described in connection with the example in FIG. 6.

In some examples, the UE may report an absolute metric value for a first beam in a first group. The UE may report a first differential metric value (e.g., a delta value) with respect to the absolute metric value for one beam in each remaining group, and a second differential metric value for each remaining beam in the multiple groups based on the one beam in a corresponding group, such as described in connection with FIG. 7.

In some examples, the beam metric for each beam in each of the multiple groups may comprise an absolute value, such as described in connection with FIG. 8. For example, each measurement for the various beams may be reported independent of the measurement for another beam.

In some examples, the UE may report multiple groups with different metrics.

The UE may report the multiple groups, at 1104 in an order based on a value of the beam metric for the multiple groups, e.g., such as described in connection with the examples for FIGS. 5 and 6.

As illustrated at 1101, the UE may receive a configuration to perform the measurements for the beams based on aspects described in connection with FIG. 4. The UE may receive a configuration to report the plurality of beams as groups that are grouped into multiple groups of more than one beam and the report including any of the aspects described in connection with any of FIGS. 5-10. The reception of the configuration may be performed, e.g., by the report configuration component 1350 of the apparatus 1302.

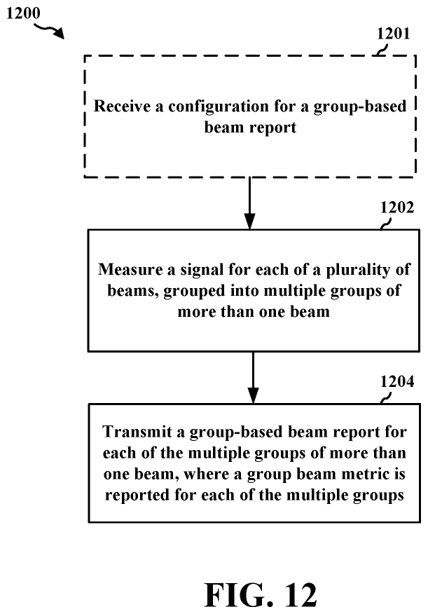

FIG. 12 is a flowchart 1200 of a method of wireless communication. The method may be performed by a UE or a component of a UE (e.g., the UE 104, 350, 402; the apparatus 1302; a processing system, which may include the memory 360 and which may be the entire UE 350 or a component of the UE 350, such as the TX processor 368, the RX processor 356, and/or the controller/processor 359).

At 1202, the UE measures a signal for each of a plurality of beams, wherein the plurality of beams are grouped into multiple groups of more than one beam. The beams may be capable of simultaneous operation, e.g., the CSI-RS and/or SSB resources may be received simultaneously by the UE either with a single spatial domain receive filter or with multiple simultaneous spatial domain receive filters. The UE may perform measurements for the beams based on aspects described in connection with FIG. 4. The plurality of beams are grouped into multiple groups of more than one beam, e.g., as described in connection with any of FIGS. 5-10. The measurement of the signal for each of the plurality of beams may be performed by the measurement component 1340 of the apparatus 1302 in FIG. 13.

At 1204, the UE transmits a group-based beam report for each of the multiple groups of more than one beam, where each group-based beam report comprised in the CSI report indicates a group beam metric for the one or more beams comprised in a corresponding group. Thus, the CSI report provides a group beam metric for each of the multiple groups. The transmission of the beam metric may be performed by the group-based beam report component 1342 via the transmission component 1334 of the apparatus 1302 in FIG. 13. The group beam metric may comprise at least one of a combined SINR, or a capacity, or other mutual information for the beams of a group. For example, the RSRP may be determined by the RSRP component 1344 of the apparatus 1302 in FIG. 13. The capacity may be determined by the capacity component 1348 of the apparatus 1302. In some examples, the UE may report an absolute metric value may for a first group, and a differential metric value with respect to the absolute metric value may be reported for each remaining group, such as described in connection with FIG. 9. In some examples, the group beam metric for each of the multiple groups may comprise an absolute value, such as described in connection with FIG. 10. The UE may report the multiple groups in an order based on a value of the group beam metric for the multiple groups, such as described in connection with FIG. 9 or FIG. 10, or as described in connection with the examples of FIGS. 5 and 6. In some examples, the UE may report multiple groups with different metrics.

As illustrated at 1201, the UE may receive a configuration to perform the measurements for the beams based on aspects described in connection with FIG. 4. The UE may receive a configuration to report the plurality of beams as groups that are grouped into multiple groups of more than one beam and the report including any of the aspects described in connection with any of FIGS. 5-10. The reception of the configuration may be performed, e.g., by the report configuration component 1350 of the apparatus 1302.

FIG. 13 is a diagram 1300 illustrating an example of a hardware implementation for an apparatus 1302. The apparatus 1302 is a UE and includes a cellular baseband processor 1304 (also referred to as a modem) coupled to a cellular RF transceiver 1322 and one or more subscriber identity modules (SIM) cards 1320, an application processor 1306 coupled to a secure digital (SD) card 1308 and a screen 1310, a Bluetooth module 1312, a wireless local area network (WLAN) module 1314, a Global Positioning System (GPS) module 1316, and a power supply 1318. The cellular baseband processor 1304 communicates through the cellular RF transceiver 1322 with the UE 104 and/or BS 102/180. The cellular baseband processor 1304 may include a computer-readable medium/memory. The computer-readable medium/memory may be non-transitory. The cellular baseband processor 1304 is responsible for general processing, including the execution of software stored on the computer-readable medium/memory. The software, when executed by the cellular baseband processor 1304, causes the cellular baseband processor 1304 to perform the various functions described supra. The computer-readable medium/memory may also be used for storing data that is manipulated by the cellular baseband processor 1304 when executing software. The cellular baseband processor 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the cellular baseband processor 1304. The cellular baseband processor 1304 may be a component of the UE 350 and may include the memory 360 and/or at least one of the TX processor 368, the RX processor 356, and the controller/processor 359. In one configuration, the apparatus 1302 may be a modem chip and include just the baseband processor 1304, and in another configuration, the apparatus 1302 may be the entire UE (e.g., see 350 of FIG. 3) and include the additional modules of the apparatus 1302.

The communication manager 1332 includes a measurement component 1340 that is configured to measure a signal for each of a plurality of beams, wherein the plurality of beams are grouped into multiple groups of more than one beam, e.g., as described in connection with 1102 and/or 1202. The communication manager 1332 further includes a group-based beam report component 1342 that receives input in the form of measurements from the measurement component 1340, the RSRP component 1344, the SINR component 1346, and/or the capacity component 1348 and is configured to a group-based beam report for each of the multiple groups of more than one beam, e.g., as described in connection with 1104 (where a beam metric is reported for each beam in each of the multiple groups) or 1204 (where a group beam metric is reported for each of the multiple groups). The apparatus 1302 may further include a report configuration component 1350 that is configured to receive a configuration to perform the measurements for the beams, e.g., as described in connection with 1101 or 1201.

The apparatus may include additional components that perform each of the blocks of the algorithm in the aforementioned FIGS. 11 and/or 12 and/or aspects performed by the UE 402 in FIG. 4. As such, each block in the aforementioned FIGS. 11 and/or 12 and/or aspects performed by the UE 402 in FIG. 4 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the cellular baseband processor 1304, includes means for measuring a signal for each of a plurality of beams, wherein the plurality of beams are grouped into multiple groups of more than one beam; and means for transmitting a group-based beam report for each of the multiple groups of more than one beam, wherein a beam metric is reported for each beam in each of the multiple groups. The apparatus may include means for measuring a signal for each of a plurality of beams, wherein the plurality of beams are grouped into multiple groups of more than one beam; and means for transmitting a group-based beam report for each of the multiple groups of more than one beam, wherein a group beam metric is reported for each of the multiple groups. The aforementioned means may be one or more of the aforementioned components of the apparatus 1302 configured to perform the functions recited by the aforementioned means. As described supra, the apparatus 1302 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

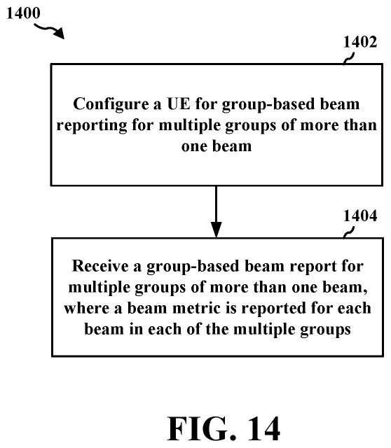

FIG. 14 is a flowchart 1400 of a method of wireless communication. The method may be performed by a base station or a component of a base station (e.g., the base station 102, 180, 310, 404; the apparatus 1602; a processing system, which may include the memory 376 and which may be the entire base station 310 or a component of the base station 310, such as the TX processor 316, the RX processor 370, and/or the controller/processor 375). The method may enable the base station to efficiently receive more comprehensive beam information.

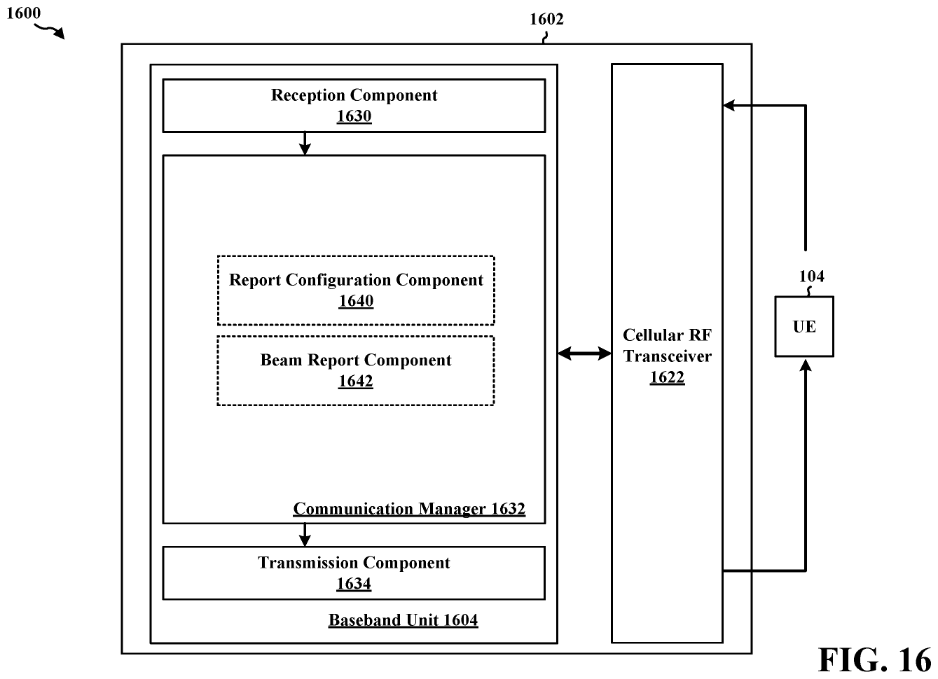

At 1402, the base station configures a UE for group-based beam reporting for multiple groups of more than one beam. The beams may be capable of simultaneous operation, e.g., simultaneous reception at the UE. The base station may configure the UE to perform measurements for the beams based on aspects described in connection with FIG. 4. The plurality of beams are grouped into multiple groups of more than one beam and the UE may be configured to report, e.g., as described in connection with any of FIGS. 5-10. The configuration for the group-based beam reporting may be performed, e.g., by the report configuration component 1640 of the apparatus 1602 in FIG. 16.

At 1404, the base station receives, from the UE, a CSI report comprising the group-based beam report for each of the multiple groups of more than one beam, where each group-based beam report comprised in the CSI report indicates a beam metric for each beam of the more than one beam in a corresponding group. Thus, a beam metric is reported for each beam in each of the multiple groups. The report may be based on the configuration transmitted at 1402. The beam metric may comprise at least one of an RSRP or an SINR, e.g., for each of the beams of the groups. The reception of the group-based beam report may be performed, e.g., by the beam report component 1642 via the reception component 1630 of the apparatus 1602 in FIG. 16.

For each group of more than one beam, the report may comprise an absolute metric value for a first beam in the group, and a differential metric value (e.g., a delta) with respect to the absolute metric value may be reported for each remaining beam in the group, such as described in connection with the example in FIG. 5.

In some examples, the report may comprise an absolute metric value for a first beam in a first group, and a differential metric value (e.g., a delta) with respect to the absolute metric value may be reported for each remaining beam in each of the multiple groups, such as described in connection with the example in FIG. 6.

In some examples, the report may comprise an absolute metric value for a first beam in a first group. A first differential metric value (e.g., a first delta) with respect to the absolute metric value may reported for one beam in each remaining group, and a second differential metric value (e.g., a second delta) may be reported for each remaining beam in the multiple groups based on the one beam in a corresponding group, such as described in connection with FIG. 7.

In some examples, the beam metric for each beam in each of the multiple groups may comprise an absolute value, such as described in connection with FIG. 8.

The report of the multiple groups may be received, at 1404 in an order based on a value of the beam metric for the multiple groups, e.g., such as described in connection with the examples for FIGS. 5 and 6.

In some examples, the base station may receive reporting information for multiple groups with different metrics. For example, an RSRP may be reported for one group, and an SINR may be reported for a second group.

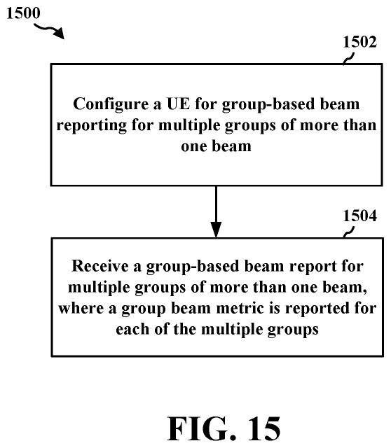

FIG. 15 is a flowchart 1500 of a method of wireless communication. The method may be performed by a base station or a component of a base station (e.g., the base station 102, 180, 310, 404; the apparatus 1602; a processing system, which may include the memory 376 and which may be the entire base station 310 or a component of the base station 310, such as the TX processor 316, the RX processor 370, and/or the controller/processor 375).

At 1502, the base station configures a UE for group-based beam reporting for multiple groups of more than one beam. The beams may be capable of simultaneous operation, e.g., simultaneous reception at the UE. The base station may configure the UE to perform measurements for the beams based on aspects described in connection with FIG. 4. The plurality of beams are grouped into multiple groups of more than one beam and the UE may be configured to report, e.g., as described in connection with any of FIGS. 5-10. The configuration for the group-based beam reporting may be performed, e.g., by the report configuration component 1640 of the apparatus 1602 in FIG. 16.

At 1504, the base station receives, from the UE, the group-based beam report for each of the multiple groups of more than one beam, where each group-based beam report comprised in the CSI report indicates a group beam metric for the one or more beams comprised in a corresponding group. Thus, the CSI report provides a group beam metric is reported for each of the multiple groups. The report may be based on the configuration transmitted at 1502. The group beam metric may comprise at least one of a combined SINR for the beams of a group, a combined capacity for the beams of a group, and/or other mutual information for the beams of a group. As an example of a combined SINR for the beams within a group may correspond to a single SINR that reflects the quality of the group of multiple beams. One example of a combined SINR is a linear weighted value based on the multiple SINRs for individual beams. The UE may indicate other types of a combined SINR other than a linear weighted value. The capacity may be based on a spectral efficiency for the beams within the group. Similar to the combined SINR, the group-based beam report may indicate a single capacity value that indicates a combined spectral efficiency for the beams within the group.

In some examples, an absolute metric value may be reported for a first group, and a differential metric value with respect to the absolute metric value may be reported for each remaining group, such as described in connection with FIG. 9. In some examples, the group beam metric for each of the multiple groups may comprise an absolute value, such as described in connection with FIG. 10. The multiple groups may be reported in an order based on a value of the group beam metric for the multiple groups, such as described in connection with FIG. 9 or FIG. 10, or as described in connection with the examples of FIGS. 5 and 6. In some examples, the base station may receive reporting information for multiple groups with different metrics. The reception of the group-based beam report may be performed, e.g., by the beam report component 1642 via the reception component 1630 of the apparatus 1602 in FIG. 16.

FIG. 16 is a diagram 1600 illustrating an example of a hardware implementation for an apparatus 1602. The apparatus 1602 is a BS and includes a baseband unit 1604. The baseband unit 1604 may communicate through a cellular RF transceiver 1622 with the UE 104. The baseband unit 1604 may include a computer-readable medium/memory. The baseband unit 1604 is responsible for general processing, including the execution of software stored on the computer-readable medium/memory. The software, when executed by the baseband unit 1604, causes the baseband unit 1604 to perform the various functions described supra. The computer-readable medium/memory may also be used for storing data that is manipulated by the baseband unit 1604 when executing software. The baseband unit 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the baseband unit 1604. The baseband unit 1604 may be a component of the base station 310 and may include the memory 376 and/or at least one of the TX processor 316, the RX processor 370, and the controller/processor 375.

The communication manager 1632 includes a report configuration component 1640 that is configured to configure a UE for group-based beam reporting for multiple groups of more than one beam, e.g., as described in connection with 1402 or 1502. The communication manager 1632 further includes a component 1642 that is configured to receive, from the UE, a group-based beam report for each of the multiple groups of more than one beam, e.g., as described in connection with 1404 (where a beam metric is reported for each beam in each of the multiple groups) or 1504 (where a group beam metric is reported for each of the multiple groups).

The apparatus may include additional components that perform each of the blocks of the algorithm in the aforementioned flowcharts of FIGS. 13 and/or 14 and aspects performed by the base station 404 in FIG. 4 As such, each block in the aforementioned flowcharts of FIGS. 13 and/or 14 and aspects performed by the base station 404 in FIG. 4 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the baseband unit 1604, includes means for configuring a UE for group-based beam reporting for multiple groups of more than one beam; and means for receiving, from the UE, the group-based beam report for each of the multiple groups of more than one beam, wherein a beam metric is reported for each beam in each of the multiple groups. The apparatus 1602 may include means for configuring a UE for group-based beam reporting for multiple groups of more than one beam; and means for receiving, from the UE, the group-based beam report for each of the multiple groups of more than one beam, wherein a group beam metric is reported for each of the multiple groups. The aforementioned means may be one or more of the aforementioned components of the apparatus 1602 configured to perform the functions recited by the aforementioned means. As described supra, the apparatus 1602 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The following aspects are illustrative only and may be combined with other aspects or teachings described herein, without limitation.

Aspect 1 is a method of wireless communication at a UE, comprising: measuring a signal for each of a plurality of beams, wherein the plurality of beams are grouped into multiple groups of more than one beam that are capable of simultaneous operation; and transmitting a CSI report comprising a group-based beam report for each of the multiple groups of more than one beam, wherein each group-based beam report comprised in the CSI report indicates a beam metric for each beam of the more than one beam in a corresponding group.

In Aspect 2, the method of Aspect 1 further includes that the beam metric comprises an RSRP.

In Aspect 3, the method of Aspect 1 further includes that the beam metric comprises an SINR.

In Aspect 4, the method of Aspect 1 further includes that the beam metric comprises an RSRP and an SINR.

In Aspect 5, the method of any of aspects 1-4 further includes that for each group of more than one beam, an absolute metric value is reported for a first beam in the group, and a differential metric value with respect to the absolute metric value is reported for each remaining beam in the group.

In Aspect 6, the method of any of aspects 1-4 further includes that that an absolute metric value is reported for a first beam in a first group, and a differential metric value with respect to the absolute metric value is reported for each remaining beam in each of the multiple groups.

In Aspect 7, the method of any of aspects 1-4 further includes that an absolute metric value is reported for a first beam in a first group, where a first differential metric value with respect to the absolute metric value is reported for one beam in each remaining group, and where a second differential metric value is reported for each remaining beam in the multiple groups based on the one beam in a corresponding group.

In Aspect 8, the method of any of aspects 1-4 further includes that the beam metric for each beam in each of the multiple groups comprises an absolute value.

In Aspect 9, the method of any of Aspects 1-8 further includes that the multiple groups are reported in an order based on a value of the beam metric for the multiple groups.

Aspect 10 is a method of wireless communication at a UE, comprising: measuring a signal for each of a plurality of beams, wherein the plurality of beams are grouped into multiple groups of more than one beam that are capable of simultaneous operation; and transmitting a CSI report comprising a group-based beam report for each of the multiple groups of more than one beam, wherein each group-based beam report comprised in the CSI report indicates a group beam metric for the one or more beams comprised in a corresponding group.

In Aspect 11, the method of Aspect 10 further includes that the group beam metric comprises a combined SINR.

In Aspect 12, the method of Aspect 10 further includes that the group beam metric comprises a capacity.

In Aspect 13, the method of Aspect 10 further includes that the group beam metric comprises a combined SINR and a capacity.

In Aspect 14, the method of any of Aspects 10-13 further includes that an absolute metric value is reported for a first group, and a differential metric value with respect to the absolute metric value is reported for each remaining group.

In Aspect 15, the method of any of Aspects 10-13 further includes that the group beam metric for each of the multiple groups comprises an absolute value.

In Aspect 16, the method of any of Aspects 10-15 further includes that the multiple groups are reported in an order based on a value of the group beam metric for the multiple groups.

In Aspect 17, a method of wireless communication at a base station, comprising: configuring a UE for group-based beam reporting for multiple groups of more than one beam; and receiving, from the UE, a CSI report comprising a group-based beam report for each of the multiple groups of more than one beam, wherein each group-based beam report comprised in the CSI report indicates a beam metric for each beam of the more than one beam in a corresponding group.

In Aspect 18, the method of aspect 17 further includes that the beam metric comprises an RSRP.

In Aspect 19, the method of aspect 17 further includes that the beam metric comprises an SINR.

In Aspect 20, the method of aspect 17 further includes that the beam metric comprises an RSRP and an SINR.

In Aspect 21, the method of any of Aspects 17-20 further includes that for each group of more than one beam, an absolute metric value is reported for a first beam in the group, and a differential metric value with respect to the absolute metric value is reported for each remaining beam in the group.

In Aspect 22, the method of any of Aspects 17-20 further includes that an absolute metric value is reported for a first beam in a first group, and a differential metric value with respect to the absolute metric value is reported for each remaining beams in each of the multiple groups.

In Aspect 23, the method of any of Aspects 17-20 further includes that an absolute metric value is reported for a first beam in a first group, wherein a first differential metric value with respect to the absolute metric value is reported for one beam in each remaining group, and wherein a second differential metric value is reported for each remaining beam in the multiple groups based on the one beam in a corresponding group.

In Aspect 24, the method of any of Aspects 17-20 further includes that the beam metric for each beam in each of the multiple groups comprises an absolute value.

In Aspect 25, the method of any of Aspects 17-23 further includes that the multiple groups are reported in an order based on a value of the beam metric for the multiple groups.

Aspect 26 is a method of wireless communication at a base station, comprising: configuring a UE for group-based beam reporting for multiple groups of more than one beam that are capable of simultaneous operation; and receiving, from the UE, a CSI report comprising a group-based beam report for each of the multiple groups of more than one beam, wherein each group-based beam report comprised in the CSI report indicates a group beam metric for the one or more beams comprised in a corresponding group.

In Aspect 27, the method of aspect 26 further includes that the group beam metric comprises a combined SINR.

In Aspect 28, the method of aspect 26 further includes that the group beam metric comprises a capacity.

In Aspect 29, the method of aspect 26 further includes that the group beam metric comprises a combined SINR and a capacity.

In Aspect 30, the method of any of Aspects 26-29 further includes that an absolute metric value is reported for a first group, and a differential metric value with respect to the absolute metric value is reported for each remaining group in the multiple groups.

In Aspect 31, the method of any of Aspects 26-29 further includes that the group beam metric for each of the multiple groups comprises an absolute value.

In Aspect 32, the method of any of Aspects 26-31 further includes that the multiple groups are reported in an order based on a value of the group beam metric for the multiple groups.

Aspect 33 is an apparatus for wireless communication including at least one processor coupled to a memory and configured to implement a method as in any of aspects 1 to 9.

Aspect 34 is an apparatus for wireless communication including means for implementing a method as in any of aspects 1 to 9.

Aspect 35 is a non-transitory computer-readable storage medium storing computer executable code, where the code when executed by a processor causes the processor to implement a method as in any of aspects 1 to 9.

Aspect 36 is an apparatus for wireless communication including at least one processor coupled to a memory and configured to implement a method as in any of aspects 10 to 16.

Aspect 37 is an apparatus for wireless communication including means for implementing a method as in any of aspects 10 to 16.

Aspect 38 is a non-transitory computer-readable storage medium storing computer executable code, where the code when executed by a processor causes the processor to implement a method as in any of aspects 10 to 16.

Aspect 39 is an apparatus for wireless communication including at least one processor coupled to a memory and configured to implement a method as in any of aspects 17 to 25.

Aspect 40 is an apparatus for wireless communication including means for implementing a method as in any of aspects 17 to 25.

Aspect 41 is a non-transitory computer-readable storage medium storing computer executable code, where the code when executed by a processor causes the processor to implement a method as in any of aspects 17 to 25.

Aspect 42 is an apparatus for wireless communication including at least one processor coupled to a memory and configured to implement a method as in any of aspects 26 to 32.

Aspect 43 is an apparatus for wireless communication including means for implementing a method as in any of aspects 26 to 32.

Aspect 44 is a non-transitory computer-readable storage medium storing computer executable code, where the code when executed by a processor causes the processor to implement a method as in any of aspects 26 to 32.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication at a user equipment (UE), comprising:
measuring a signal for each of a plurality of beams, wherein the plurality of beams are grouped into multiple groups of more than one beam that are capable of simultaneous operation; and
transmitting a channel state information (CSI) report comprising a group-based beam report for each of the multiple groups of more than one beam, wherein each group-based beam report comprised in the CSI report indicates a beam metric for each beam in a corresponding group.

2. The method of claim 1, wherein the beam metric comprises a reference signal received power (RSRP).

3. The method of claim 1, wherein the beam metric comprises a signal to interference and noise ratio (SINR).

4. The method of claim 1, wherein the beam metric comprises a reference signal received power (RSRP) and a signal to interference and noise ratio (SINR).

5. The method of claim 1, wherein for each group of more than one beam, the UE reports an absolute metric value for a first beam in the group, and a differential metric value with respect to the absolute metric value is reported for each remaining beam in the group.

6. The method of claim 1, wherein the UE reports an absolute metric value for a first beam in a first group and a differential metric value with respect to the absolute metric value is reported for each remaining beam in each of the multiple groups.

7. The method of claim 1, wherein the UE reports an absolute metric value reported for a first beam in a first group,
wherein a first differential metric value with respect to the absolute metric value is reported for one beam in each remaining group, and
wherein a second differential metric value is reported for each remaining beam in the multiple groups based on the one beam in the corresponding group.

8. The method of claim 1, wherein the UE reports the multiple groups in an order based on a value of the beam metric for the multiple groups.

9. A method of wireless communication at a user equipment (UE), comprising:
measuring a signal for each of a plurality of beams, wherein the plurality of beams are grouped into multiple groups of more than one beam that are capable of simultaneous operation; and
transmitting a channel state information (CSI) report comprising a group-based beam report for each of the multiple groups of more than one beam, wherein each group-based beam report comprised in the CSI report indicates a group beam metric for the one or more beams comprised in a corresponding group.

10. The method of claim 9, wherein the group beam metric comprises a combined signal to interference and noise ratio (SINR).

11. The method of claim 9, wherein the group beam metric comprises a capacity.

12. The method of claim 9, wherein the group beam metric comprises a combined signal to interference and noise ratio (SINR) and a capacity.

13. The method of claim 9, wherein the UE reports an absolute metric value for a first group, and a differential metric value with respect to the absolute metric value is reported for each remaining group.

14. The method of claim 9, wherein the UE reports the multiple groups in an order based on a value of the group beam metric for the multiple groups.

15. A method of wireless communication at a base station, comprising:
configuring a user equipment (UE) for group-based beam reporting for multiple groups of more than one beam that are capable of simultaneous operation; and
receiving, from the UE, a channel state information (CSI) report comprising a group-based beam report for each of the multiple groups of more than one beam, wherein each group-based beam report comprised in the CSI report indicates a beam metric for each beam in a corresponding group.

16. The method of claim 15, wherein the beam metric comprises a reference signal received power (RSRP) or a signal to interference.

17. The method of claim 15, wherein the beam metric comprises a signal to interference and noise ratio (SINR).

18. The method of claim 15, wherein the beam metric comprises a reference signal received power (RSRP) and a signal to interference and noise ratio (SINR).

19. The method of claim 15, wherein for each group of more than one beam, the base station receives an absolute metric value reported for a first beam in the group and a differential metric value with respect to the absolute metric value is reported for each remaining beam in the group.

20. The method of claim 15, wherein the base station receives an absolute metric value that is reported for a first beam in a first group, and a differential metric value with respect to the absolute metric value for each remaining beams in each of the multiple groups.

21. The method of claim 15, wherein the base station receives an absolute metric value for a first beam in a first group,
wherein a first differential metric value with respect to the absolute metric value is reported for one beam in each remaining group, and
wherein a second differential metric value is reported for each remaining beam in the multiple groups based on the one beam in the corresponding group.

22. The method of claim 15, wherein the base station receives reporting for the multiple groups in an order based on a value of the beam metric for the multiple groups.

23. A method of wireless communication at a base station, comprising:
configuring a user equipment (UE) for group-based beam reporting for multiple groups of more than one beam that are capable of simultaneous operation; and
receiving, from the UE, a channel state information (CSI) report comprising a group-based beam report for each of the multiple groups of more than one beam, wherein each group-based beam report comprised in the CSI report indicates a group beam metric for the one or more beams comprised in a corresponding group.

24. The method of claim 23, wherein the group beam metric comprises a combined signal to interference and noise ratio (SINR).

25. The method of claim 23, wherein the group beam metric comprises a capacity.

26. The method of claim 23, wherein the group beam metric comprises a combined signal to interference and noise ratio (SINR) and a capacity.

27. The method of claim 23, wherein the CSI report includes an absolute metric value is reported for a first group, and a differential metric value with respect to the absolute metric value is reported for each remaining group in the multiple groups.

28. The method of claim 23, wherein the base station receives reporting for the multiple groups in an order based on a value of the group beam metric for the multiple groups.
